(19) United States
(12) Patent Application Publication
(10) Pub. No.: US 2021/0014433 A1
(43) Pub. Date: Jan. 14, 2021

(54) Image Processing Method and Image Processing System Capable of Calibrating Images

(71) Applicant: InnoLux Corporation, Miao-Li County (TW)

(72) Inventor: Shih-Hsien Yang, Miao-Li County (TW)

(21) Appl. No.: 16/904,494

(22) Filed: Jun. 17, 2020

(30) Foreign Application Priority Data
Jul. 10, 2019 (CN) 201910620058.9

(51) Int. Cl. H04N 5/32

(52) U.S. Cl. CPC H04N 5/3205

(57) ABSTRACT

An image processing method includes setting a detection panel with an active region, acquiring raw image data by using the detection panel, partitioning the active region into a first region and a second region, discharging at least a part of the electrical charges in the first region by using a particular scanning process, acquiring calibration data through the detection panel, and calibrating the raw image data to generate calibrated image data according to the calibration data.

### BACKGROUND OF THE DISCLOSURE

### 1. Field of the Disclosure

The present disclosure relates to an image processing method and an image processing system, and more particularly, an image processing method and an image processing system capable of calibrating images.

### 2. Description of the Prior Art

With the rapid developments of technologies, various visible and invisible light processing technologies are widely adopted in our daily life. For example, medical personnel can use an X-ray flat panel detector (FPD) for generating images in order to perform various medical activities. However, image quality may be reduced due to various factors when generating and reading images. How to optimize image quality and how to shorten the image processing time are two important issues for image processing technologies.

### SUMMARY OF THE DISCLOSURE

The present disclosure aims at providing an image processing method and providing an image processing system for rapidly or optimally calibrating images.

In an embodiment of the present disclosure, an image processing method is disclosed. The image processing method includes acquiring raw image data, executing a particular scanning process, acquiring a calibration data, and calibrating the raw image data.

In an embodiment of the present disclosure, an image processing system is disclosed. The image processing system includes a detection panel configured to acquire raw image data, an analog-to-digital converter coupled to the detection panel for converting an electrical signal outputted from the detection panel to a binary signal, a processor coupled to the analog-to-digital converter and configured to process the binary signal, and a gate driving circuit coupled to the processor and the detection panel and configured to drive scan lines of the detection panel, wherein after the detection panel acquires the raw image data, the processor executes a particular scanning process, the detection panel acquires calibration data, and the processor calibrates the raw image data.

These and other objectives of the present disclosure will become obvious to those of ordinary skill in the art after reading the following detailed description of the embodiment that is illustrated in the various figures and drawings.

### BRIEF DESCRIPTION OF THE DRAWINGS

FIG. 1 is a block diagram of an image processing system according to an embodiment of the present disclosure.

FIG. 2 is a schematic illustration of introducing the image processing system in FIG. 1 to an X-ray flat panel detector.

FIG. 3 is a schematic illustration of introducing the image processing system in FIG. 1 to a camera.

FIG. 4 is a time flow illustration of executing an image processing method with the image processing system in FIG. 1.

FIG. 5 is a schematic illustration of resetting a detection panel in the image processing method in FIG. 4.

FIG. 6 is a schematic illustration of executing a particular scanning process in the image processing method in FIG. 4.

FIG. 7 is a schematic illustration of driving waveforms in the image processing method in FIG. 4.

FIG. 8 is a schematic illustration of raw image data of the image processing system in FIG. 1.

FIG. 9 is a schematic illustration of calibration data of the image processing system in FIG. 1.

FIG. 10 is a schematic illustration of calibrated image data of the image processing system in FIG. 1.

FIG. 11 is a flow chart of executing the image processing method with the image processing system in FIG. 1.

### DETAILED DESCRIPTION

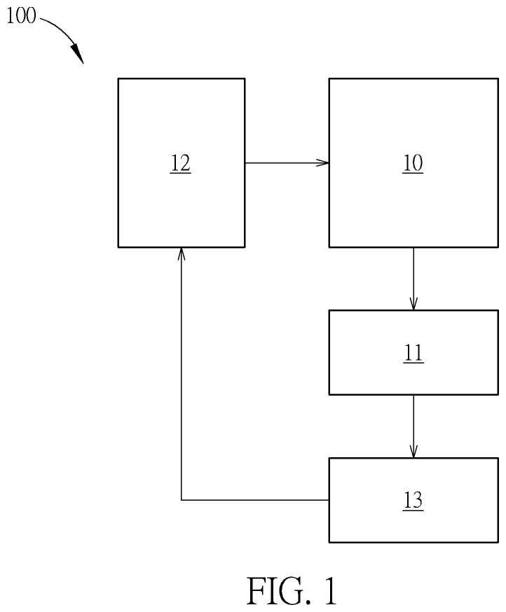

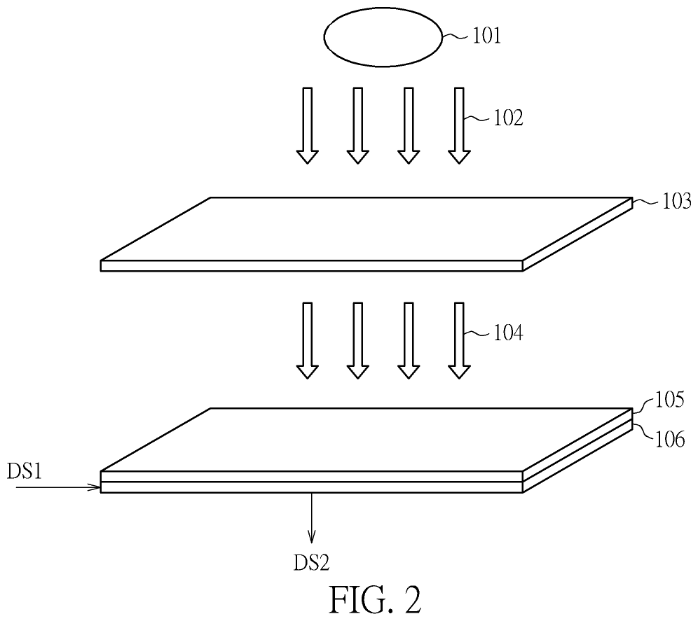

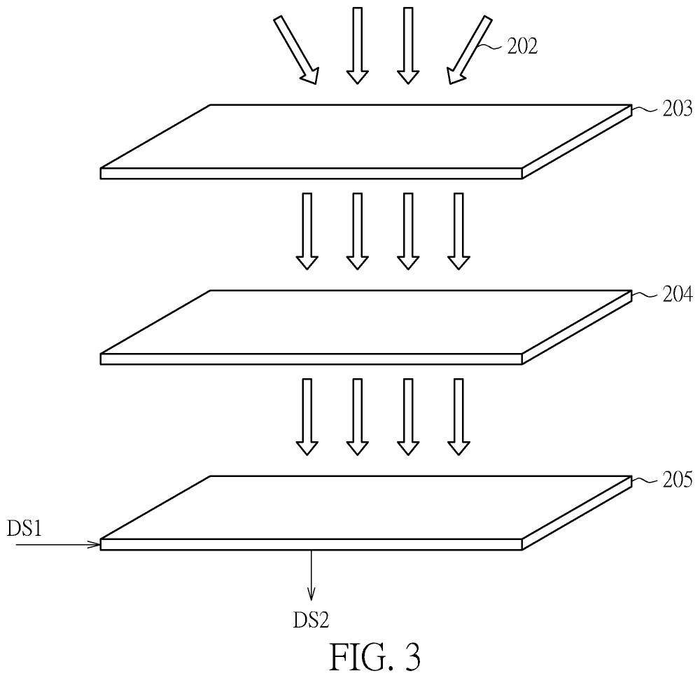

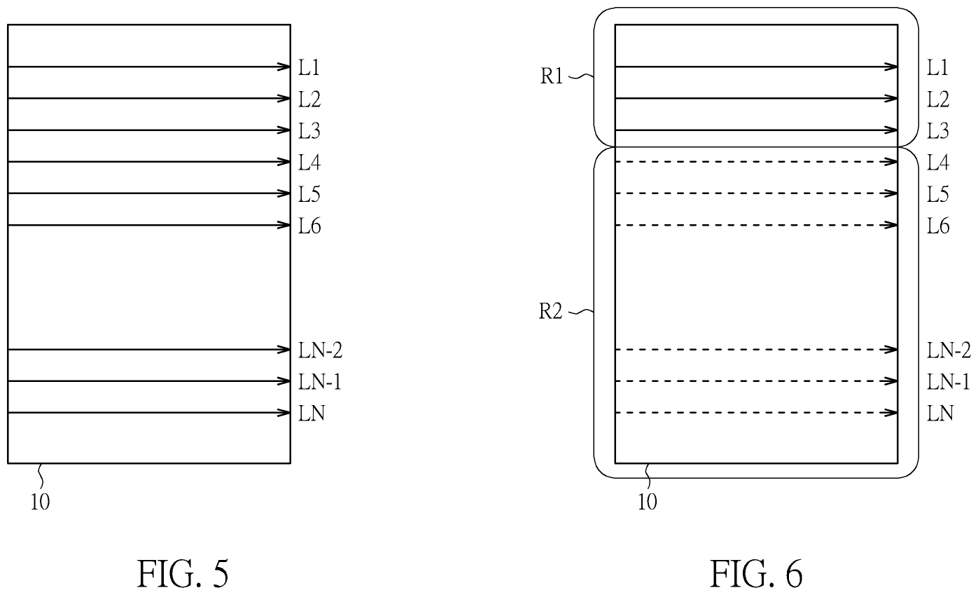

FIG. 1 is a block diagram of an image processing system 100 according to an embodiment of the present disclosure. FIG. 2 is a schematic illustration of introducing the image processing system 100 to an X-ray flat panel detector. FIG. 3 is a schematic illustration of introducing the image processing system 100 to a camera. Here, the detection panel of the image processing system 100 can be applied to any visible light imaging system or invisible light imaging system, such as an X-ray flat panel detector (FPD) or a camera. As shown in FIG. 1, the image processing system 100 can include a detection panel 10, an analog-to-digital converter 11, a gate driving circuit 12, and a processor 13. For example, the detection panel 10 can be the X-ray flat panel detector for generating image data corresponding to an invisible light generated by a light source (i.e., such as an X-ray light source). The detection panel 10 can also be a photosensitive component of the camera for generating the image data corresponding to a visible light generated by a light source (i.e., such as an ambient light source or a photoflash). The detection panel 10 is capable of converting optical signals into electrical signals. Any reasonable application of the detection panel 10 falls into the scope of the present disclosure. The analog-to-digital converter 11 is coupled to the detection panel 10 for converting the electrical signals outputted from the detection panel 10 into binary signals. The processor 13 is coupled to the analog-to-digital converter 11 for processing the image data carried by the binary signals outputted from the analog-to-digital converter 11 in order to optimize image quality. The processor 13 can be any type of signal processing circuit, such as a central processing unit (CPU), a graphics processing unit (GPU), a field-programmable gate array (FPGA), or a combining of aforementioned circuits and peripheral circuits. The gate driving circuit 12 is coupled to the processor 13 and the detection panel 10 for driving pixels located in the detection panel 10. These pixels are coupled with scan lines (such as scan lines L1 to LN in FIG. 5). A region of the detection panel 10 where the pixels are located in can be regarded as an active region of the detection panel 10 for generating electrical signals. When the detection panel 10 receives a light and executes an exposure process for a period of time, the processor 13 can acquire image data generated from the detection panel 10. Since the image processing system 100 can be introduced to a X-ray flat panel detector or a camera, details of photosensitive structures of the X-ray flat panel detector and the camera are illustrated later. Further, details of executing the image processing method for calibrating offsets by using the image processing system 100 are also illustrated later.

In FIG. 2, the X-ray flat panel detector includes a light source 101, an X-ray conversion layer 103, a photodiode layer 105, and a thin-film transistor (TFT) panel 106. The light source 101 emits an X-ray 102. The X-ray 102 is an invisible light. The X-ray conversion layer 103 faces the light source 101 for converting the invisible X-ray 102 into a visible light 104. The photodiode layer 105 faces the X-ray conversion layer 103 for converting the visible light 104 into electrical charges. The thin-film transistor panel 106 is coupled to the photodiode layer 105 for storing an electrical signal DS2 (i.e., an amount of charges carried by each pixel) corresponding to each pixel. After a driving signal DS1 is received by the thin-film transistor panel 106, the thin-film transistor panel 106 outputs the electrical signal DS2 to the analog-to-digital converter 11 of FIG. 1. In other words, in the X-ray flat panel detector, the detection panel 10 can include at least the X-ray conversion layer 103, the photodiode layer 105, and the thin-film transistor panel 106. The thin-film transistor panel 106 can be driven by the gate driving circuit 12 in FIG. 1. For example, the pixels in the thin-film transistor panel 106 coupled to all scan lines can be sequentially scanned by using the gate driving circuit 12 for outputting the electrical signal DS2.

In FIG. 3, the camera includes a lens module 203, a color filtering module 204, and a photosensitive element 205. The color filtering module 204 is located between the lens module 203 and the photosensitive element 205. The lens module 203 is used for receiving a visible light 202. The visible light 202 can be generated by an ambient light source or a photoflash. When the lens module 203 receives the visible light 202, the visible light 202 can be concentrated and then outputted to the color filtering module 204. The color filtering module 204 can be a Bayer filter module or a color filter array (CFA) module having any reasonable color filter arrangement. The energy of the filtered light passing through the color filtering module 204 can be received by the photosensitive element 205. The photosensitive element 205 faces the color filtering module 204 for receiving the filtered light energy and generating the electrical signal DS2 accordingly. Here, the photosensitive element 205 can include at least one charge-coupled device (CCD) or at least one complementary metal-oxide semiconductor (CMOS). However, the photosensitive element 205 is not limited thereto. After a driving signal DS1 is received by the photosensitive element 205, the photosensitive element 205 outputs the electrical signal DS2 to the analog-to-digital converter 11 in FIG. 1. The photosensitive element 205 can be driven by the gate driving circuit 12 in FIG. 1. In other words, when the image processing system 100 is introduced to a camera, the detection panel 10 can include at least the photosensitive element 205. Based on such architecture or circuit structure of the disclosure, any reasonable technology modification fallen into the scope of the present disclosure is acceptable. For example, the camera in the FIG. 3 can further includes algorithms or hardware for eliminating Moire effects and/or false color effects.

However, for simplicity, the X-ray flat panel detector are taken as an example to illustrate the details of the image processing method and the image processing system of the disclosure.

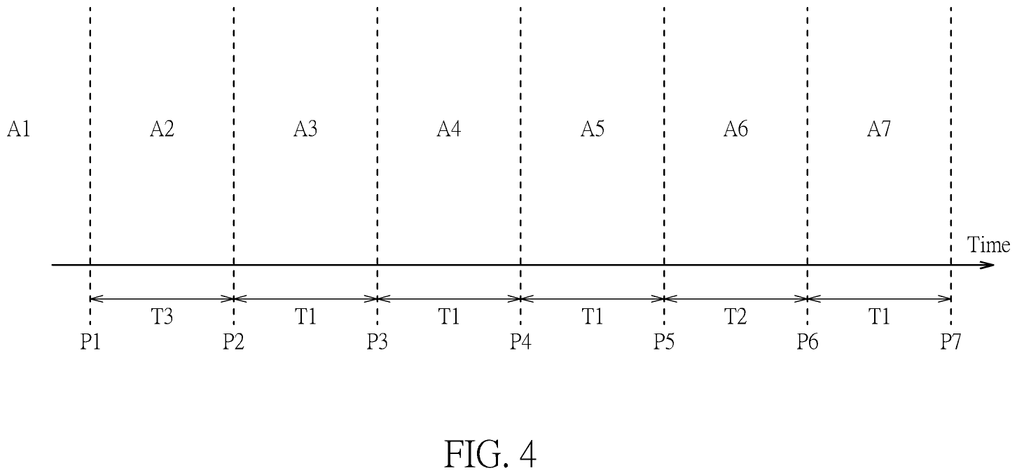

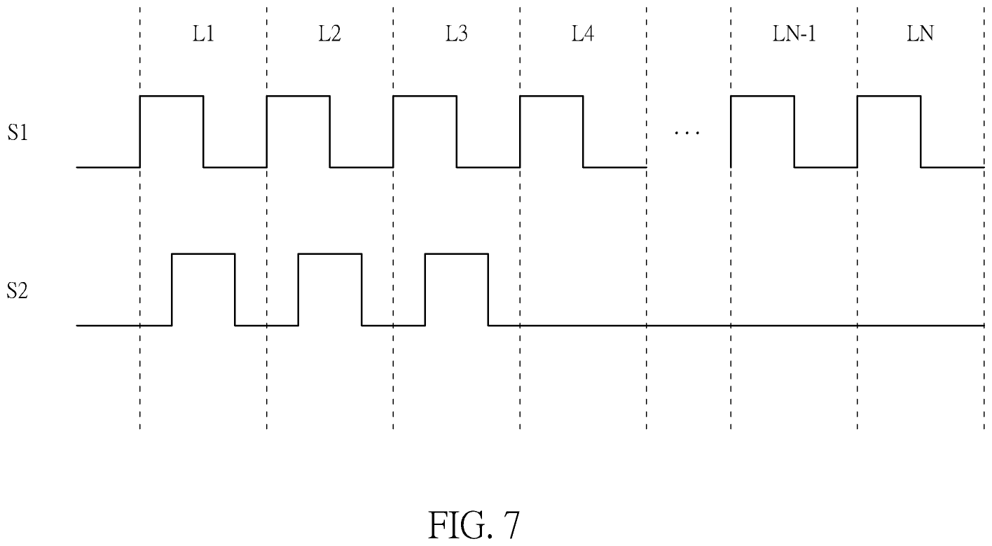

FIG. 4 is a time flow illustration of executing the image processing method with the image processing system 100. FIG. 5 is a schematic illustration of resetting a detection panel 100 in the image processing method in FIG. 4. FIG. 6 is a schematic illustration of executing a particular scanning process in the image processing method in FIG. 4. FIG. 7 is a schematic illustration of driving waveforms in the image processing method in FIG. 4. As known, even if the light source 101 does not emit the X-ray, a small amount of charges may remain in each pixel of the detection panel 10 due to various reasons such as the ambient light or a leakage current of the thin-film transistors. Therefore, the detection panel 10 has to repeatedly execute a resetting process for discharging residual electrical charges in the pixels. The resetting process corresponds to step Al in FIG. 4. In step A2 in FIG. 4, the light source 101 is turned on for emitting the X-ray. After the detection panel 10 receives the light (i.e., the X-ray), the detection panel 10 generates the electrical signal DS2. Then, in step A3, the image processing system 100 can acquire raw image data. Then, the gate driving circuit 12 can execute the resetting process in step A4 for discharging at least a part of electrical charges in the active region of the detection panel 10. Particularly, similar to step A1, after the raw image data is acquired, a small amount of charges may remain in each pixel of the detection panel 10. Therefore, in step A4, the gate driving circuit 12 outputs a shift pulse signal S1 to the scan lines L1 to LN of the active region for driving the pixels coupled to the scan lines in order to discharge residual charges. Then, a particular scanning process is executed in step A5 for discharging at least a part of electrical charges in the first region. By doing so, status of the scan lines L1 to LN of the detection panel 10 when the light source 101 starts to emit the X-ray can be simulated. The detection panel 10 can repeatedly execute the resetting process (i.e., steps A1 and A4) for discharging the residual charges of the pixels, but the light source 101 and the detection panel 10 may not be synchronized. That is, when the light source 101 starts to emit the X-ray, the detection panel 10 operated under the resetting process may be immediately interrupted. Therefore, only a part of residual charges in the pixels of some scan lines are discharged. Another part of residual charges still remain in the detection panel 10. As shown in FIG. 6, when the light source 101 starts to emit the X-ray, since the resetting process is immediately interrupted, only the pixels coupled to the scan line L1 to the scan line L3 corresponding to the first region R1 on the detection panel 10 are discharged by using the resetting process. However, no resetting process is introduced to the pixels coupled to the scan line L4 to the scan line LN corresponding to the second region R2 on the detection panel 10. Therefore, some electrical charges still remain in the pixels in the second region R2, leading to an offset between the raw image data and the real image data. Such offset results in degradation of the image quality. Therefore, in the present disclosure, after the resetting process, the particular scanning process is further executed for discharging at least part of electrical charges in the first region R1. The particular scanning process in the first region R1 is used for simulating the allocations of electrical charges in the pixels of the detection panel 10 when the light source 101 starts to emit the X-ray. The simulated result can be used for compensating the offset between the raw image data and the real image data. Here, a partitioning process can be executed for partitioning the active region into the first region R1 and the second region R2 before the particular scanning process. It should be noted that the partitioning process is only needed to be completed before the particular scanning process. In other words, the partitioning process can be executed in any step before the particular scanning process. Further, the ranges of the first region R1 and the second region R2 are not limited to FIG. 6. That is, the first region R1 and the second region R2 can be defined according to a “boundary” scan line corresponding to a timing of interrupting the resetting process when the light source 101 starts to emit the X-ray.

As previously mentioned, the electrical charges of the pixels corresponding to the scan line L1 to the scan line L3 in the first region R1 are discharged by using the resetting process. The electrical charges of the pixels corresponding to the scan line L4 to the scan line LN in the second region R2 still remain in the detection panel 10. The image processing system 100 can process the aforementioned steps according to the waveforms shown in FIG. 7. In FIG. 7, the shift pulse signal S1 can be a clock signal corresponding to the scan line L1 to the scan line LN when the detection panel 10 outputs the electrical signal DS2 or is operating in the resetting process. Here, when the shift pulse signal S1 is high, the thin-film transistors of the pixels coupled to a scan line are operated under a turn-on state. Therefore, electrical charges in the pixels can be discharged. Conversely, when the shift pulse signal S1 is low, the thin-film transistors of the pixels coupled to a scan line are operated under a turn-off state. Therefore, electrical charges in the pixels cannot be discharged. When the particular scanning process is executed, the gate driving circuit 12 outputs the output enable signal S2 to the scan lines corresponding to the first region R1. The first region R1 and second region R2 are previously defined. Similarly, when the output enable signal S2 is high, thin-film transistors of the pixels coupled to a scan line are operated under the turn-on state. Therefore, electrical charges in the pixels can be discharged. The scan lines which don't receive the output enable signal S2 is still under the turn-off state. By using the particular scanning process in step A5, the state of the scan lines L1 to LN of the detection panel 10 when the light source 101 starts to emit the X-ray can be simulated. A time length of processing the particular scanning process can be denoted as T1. After the processor 13 executes the particular scanning process of the detection panel 10, in step A6, the detection panel 10 enters an idle state for a period of time T2. Then, in step A7, the processor 13 acquires the calibration data through the detection panel 10. In other words, the calibration data is acquired after the particular scanning process and the idle state. As previously mentioned, the particular scanning process can be used for simulating the allocations of the electrical charges in the pixels in the detection panel 10 when the light source 101 starts to emit the X-ray. Therefore, the calibration data can be regarded as dark state image data corresponding to the allocations of residual charges of the pixels in the detection panel 10 when the light source 101 starts to emit the X-ray. Then, the processor 13 can execute a data calibration process for eliminating the offset of the raw image data according to the calibration data. By doing so, the processor 13 can generate calibrated image data.

As shown in FIG. 4, in the image processing system 100, a time length of step A3 for acquiring the raw image data, a time length of step A4 for executing the resetting process, a time length of step A5 for executing the particular scanning process, and a time length of step A7 for acquiring the calibrated image data are equal to T1. However, the present disclosure is not limited thereto. In some embodiments, the time lengths required by the aforementioned steps are not exactly the same. Further, a time length T3 of step A2 for emitting the X-ray by the light source 101 is different from a time length T1 required to execute the particular scanning process. However, the time length T3 and the time length T1 are not limited thereto. For example, the time length T1 and the time length T3 can be identical. Further, in some embodiments, the time length T2 of idle state can be different from the time length T1 required to execute the particular scanning process. However, the time length T2 and the time length T1 are not limited thereto. For example, in some embodiments, the time length T2 and the time length T1 can be substantially identical. In some embodiments, the time length T1 can be defined within a range from 300 milliseconds to 600 milliseconds, and the time length T2 and the time length T3 can satisfy a condition as 0.9×T3<T2<1.1×T3. However, the correlations among the time length Tl, the time length T2, and the time length T3 can be reasonably adjusted in some embodiments. Further, the sequence of step A5 (executing the particular scanning process) and step A6 (entering the idle state) can be interchanged. Any reasonable technology modification fallen into the scope of the present disclosure is acceptable.

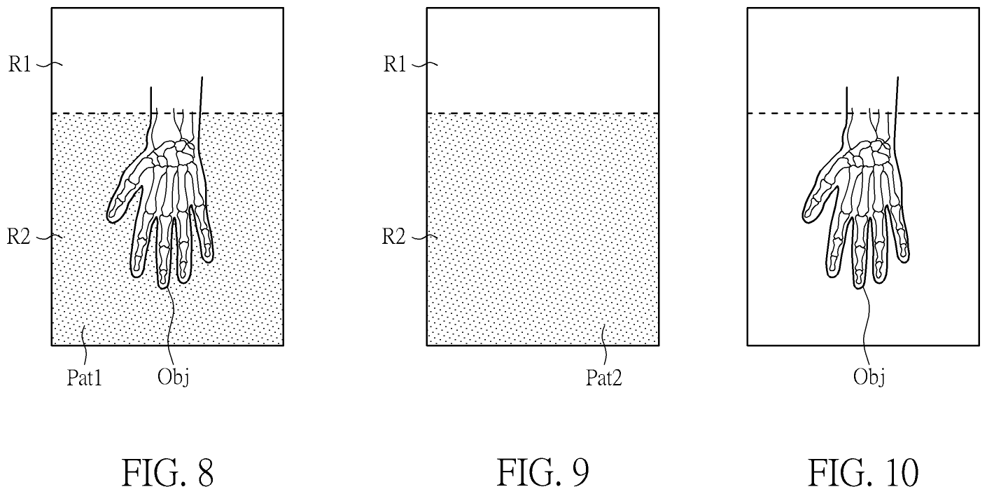

FIG. 8 is a schematic illustration of the raw image data of the image processing system 100. FIG. 9 is a schematic illustration of the calibration data of the image processing system 100. FIG. 10 is a schematic illustration of the calibrated image data of the image processing system 100. In FIG. 8 to FIG. 10, when the light source 101 starts to emit the X-ray, the resetting process of the detection panel 10 is interrupted (or say, immediately terminated). Therefore, the electrical charges of the pixels coupled to the scan lines in the first region R1 can be discharged, but the electrical charges of the pixels coupled to the scan lines in the second region R2 cannot be discharged. Therefore, the electrical charges remaining in the second region R2 of the detection panel 10 result in at least one first interference pattern Pat1 in an exposed image. In other words, the raw image in FIG. 8 includes at least one main object Obj and a first interference pattern Pat1. If the image data is expressed in a form of hue parameters, the hue parameters of a pixel located on coordinates (i, j) can be expressed as

Raw image (i, j)

After the particular scanning process is executed for simulating the allocations of electrical charges in the pixels coupled to the scan line L1 to the scan line LN in the detection panel 10 when the light source 101 starts to emit X-ray, then a calibration data corresponding to a dark state image can be acquired. In other words, as shown in FIG. 9, for the dark state image, no main object Obj is introduced in the calibration data. However, the calibration data in FIG. 9 includes at least one second interference pattern Pat2. If the calibration data in FIG. 9 is expressed in a form of hue parameters, the hue parameters of a pixel located on coordinates (i, j) can be expressed as

Offset (i, j)

In the image processing system 100, the method of optimizing the image quality is to reduce non-uniform hues in the exposed image. Therefore, the image processing system 100 can calibrate at least a part of the first interference pattern Pat1 of the raw image data for generating the calibrated image data according to the calibration data. For example, the raw image in FIG. 8 includes at least one image object Obj and the first interference pattern Pat1. The image of the calibration data in FIG. 9 includes at least one second interference pattern Pat2. Therefore, the processor 13 can acquire difference values between the hue parameters of a pixel in the raw image (i.e., Raw image(i, j)) and the hue parameters of a pixel in the calibration data (i.e., Offset (i, j)) for generating hue parameters of the calibrated image. That is, the calibrated image is generated by subtracting the pixel hue parameter of the calibration data from the pixel hue parameter of the raw image data. The hue parameter of a pixel located on coordinates (i, j) in a calibrated image can be expressed as

C(i, j)

And the subtraction can be expressed as

C(i, j)=|Raw image (i, j)−Offset (i, j)|

In other words, in the calibrated image shown in FIG. 10, after the image calibration process is executed, the first interference pattern Pat1 is reduced. When the first interference pattern Pat1 and the second interference pattern Pat2 are identical, the first interference pattern Pat1 can be completely removed, and the corrected image in FIG. 10 only includes the at least one main object Obj. By doing so, the image quality can be improved. Further, as previously mentioned, the processor 13 can acquire difference values between the hue parameters of the raw image and the hue parameters of the calibration data for generating the hue parameters of the calibrated image. However, the disclosure is not limited thereto. Any reasonable linear or non-linear calibrated image generating method is also applicable in the present disclosure.

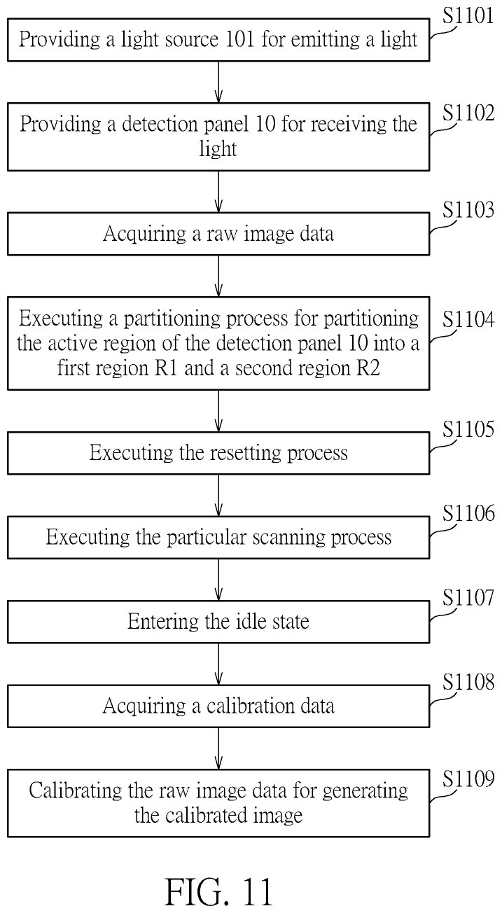

FIG. 11 is a flow chart of executing the image processing method by the image processing system 100. The image processing method can include step S1101 to step S1109. Any reasonable technology modification fallen into the scope of the present disclosure is acceptable. Step S1101 to step S1109 are illustrated below.

step S1101: providing a light source 101 for emitting a light;

step S1102: providing a detection panel 10 for receiving the light;

step S1103: acquiring a raw image data;

step S1104: executing a partitioning process for partitioning the active region of the detection panel 10 into a first region R1 and a second region R2;

step S1105: executing the resetting process;

step S1106: executing the particular scanning process;

step S1107: entering the idle state;

step S1108: acquiring a calibration data;

step S1109: calibrating the raw image data for generating the calibrated image.

Details of step S1101 to step S1109 are illustrated previously. Thus, they are omitted here. The image processing system 100 can use the image processing method for mitigating the interference pattern of the raw image. Therefore, the quality of the calibrated image outputted from the image processing system 100 can be improved.

In Summary, the present disclosure illustrates an image processing method and an image processing system. The image processing method can be executed by the image processing system. The image processing method can simulate the allocations of electrical charges in the pixels in a detection panel when a light source starts to emit a light. The image processing method only requires a calibration data for calibrating a offset of an exposed raw image. Therefore, computational complexity and image processing time of the image processing method in the present disclosure can be reduced.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An image processing method comprising:
acquiring a raw image data;
executing a particular scanning process;
acquiring a calibration data; and
calibrating the raw image data.

2. The method of claim 1, further comprising:
providing a light source for emitting a light before acquiring the raw image data; and
providing a detection panel for receiving the light before acquiring the raw image data,
wherein the detection panel comprises an active region.

3. The method of claim 2, further comprising:
executing a partitioning process before executing the particular scanning process;
wherein the partitioning process is used for partitioning the active region of the detection panel into a first region and a second region.

4. The method of claim 3, wherein the particular scanning process is used for discharging at least a part of electrical charges in the first region.

5. The method of claim 2, further comprising:
executing a resetting process after acquiring the raw image data;
wherein the resetting process is used for discharging at least a part of electrical charges in the active region of the detection panel.

6. The method of claim 5, wherein a time length for executing the resetting process and a time length for executing the particular scanning process are identical.

7. The method of claim 1, further comprising:
entering an idle state after executing the particular scanning process.

8. The method of claim 7, wherein a time length for entering the idle state and a time length for executing the particular scanning process are different.

9. The method of claim 1, wherein a time length for acquiring the raw image data and a time length for executing the particular scanning process are identical.

10. The method of claim 1, wherein the raw image data comprises at least a first pixel hue parameter, the calibration data comprises at least a second pixel hue parameter, and a calibrated image data is generated by subtracting the at least a second pixel hue parameter from the at least a first pixel hue parameter.

11. An image processing system comprising:
a detection panel configured to acquire raw image data;
an analog-to-digital converter coupled to the detection panel for converting an electrical signal outputted from the detection panel to a binary signal;
a processor coupled to the analog-to-digital converter and configured to process the binary signal; and
a gate driving circuit coupled to the processor and the detection panel, and the gate driving circuit configured to drive scan lines of the detection panel;
wherein after the detection panel acquires the raw image data, the processor executes a particular scanning process, the detection panel acquires calibration data, and the processor calibrates the raw image data.

12. The system of claim 11, wherein the detection panel is used for receiving a light generated by a light source, and the detection panel comprises an active region.

13. The system of claim 12, wherein the processor executes a partitioning process before executing the particular scanning process, and the partitioning process is used for partitioning the active region of the detection panel into a first region and a second region.

14. The system of claim 13, wherein the particular scanning process is used for discharging at least a part of electrical charges in the first region.

15. The system of claim 12, wherein the processor executes a resetting process after acquiring the raw image data, and the resetting process is used for discharging at least a part of electrical charges in the active region of the detection panel.

16. The system of claim 15, wherein a time length for executing the resetting process and a time length for executing the particular scanning process are identical.

17. The system of claim 11, wherein the detection panel enters an idle state after executing the particular scanning process.

18. The system of claim 17, wherein a time length for entering the idle state and a time length for executing the particular scanning process are different.

19. The system of claim 11, wherein a time length for acquiring the raw image data and a time length for executing the particular scanning process are identical.

20. The system of claim 11, wherein the raw image data comprises at least a first pixel hue parameter, the calibration data comprises at least a second pixel hue parameter, and the calibrated image is generated by subtracting the at least a second pixel hue parameter from the at least a first pixel hue parameter.
